(19) United States
(12) Patent Application Publication
(10) Pub. No.: US 2020/0126050 A1
(43) Pub. Date: Apr. 23, 2020

(54) IoT GATEWAY AND DESTINATION CLOUD SERVER

(71) Applicant: Nokia Technologies Oy, Espoo (FI)

(72) Inventor: Teemu Savolainen, Nokia (FI)

(21) Appl. No.: 16/477,546

(22) PCT Filed: Jan. 19, 2017
(86) PCT No.: PCT/US2017/014059

§ 371 Date: Jul. 12, 2019

(51) Int. Cl. G06Q 20/10; G06F 16/27; H04L 29/08; H04L 12/66; H04L 12/14; H04L 12/24

(52) U.S. Cl. CPC G06Q 20/10; G06F 16/27; H04L 67/10; G16Y 10/50; H04L 12/66; H04L 12/1403; H04L 41/0806; H04L 67/12

(57) ABSTRACT

Methods and apparatus, including computer program products, are provided for internet of things data forwarding. In some example embodiments, there may be provided a method that includes receiving, from an internet of things node, data to be forwarded to a cloud server and an identity of the cloud server; performing at least one check of the internet of things node and/or the cloud server, to assess whether the apparatus is likely to be reimbursed for a charge for forwarding the data to the cloud server; and forwarding, based on the at least one check, the data to the cloud server. Related systems, methods, and articles of manufacture are also described.

### FIELD

The subject matter described herein relates to the Internet of Things (IoT) including IoT nodes, gateways, and cloud servers.

### BACKGROUND

Internet of Things (IoT) nodes are expected to be deployed in quantities of millions, if not billions, or more. Some of these IoT nodes will be mobile, and some of the IoT nodes may be wearable devices, such as health and/or fitness related trackers and/or the like. Some of the IoT nodes may also be deployed to a fixed location, such as an IoT sensor configured to measure or monitor. In some cases, the IoT node may not have direct Internet access and may thus need to access an IoT gateway that provides the Internet access, enabling the IoT node to forward IoT data via the IoT gateway to an Internet coupled cloud server, at which additional processing and/or analysis can be performed on the IoT node's data.

### SUMMARY

Methods and apparatus, including computer program products, are provided for internet of things data forwarding.

In some example embodiments, there may be provided a method that includes receiving, from an internet of things node, data to be forwarded to a cloud server and an identity of the cloud server; performing at least one check of the internet of things node and/or the cloud server, to assess whether the apparatus is likely to be reimbursed for a charge for forwarding the data to the cloud server; and forwarding, based on the at least one check, the data to the cloud server.

In some variations, one or more of the features disclosed herein including the following features can optionally be included in any feasible combination. A charging record and/or debit record for the forwarded data may be sent, when the forwarded data is sent to the cloud server. The charging record and/or debit record may be sent to a distribute database including blockchain and/or sent to the cloud server. The charging record may be sent to the cloud server after the at least one check is performed and after the forwarded data is sent to the cloud server. The at least one check to assess whether the apparatus is likely to be reimbursed may include a check of a first certificate for the internet of things node and/or a second certificate for the cloud server. The at least one check to assess whether the apparatus is likely to be reimbursed may include a check of a reputation of the internet of things node and/or the cloud server for reimbursement for forwarding data to the cloud server. The check of the reputation may include verifying the reputation at a database including historical data regarding past reimbursements for forwarding data to the cloud server. The check of the reputation may include verifying the reputation at a distributed database including blockchain. The at least one check to assess whether the apparatus is likely to be reimbursed may include a verification of whether the internet of things node and/or the cloud server have credit for reimbursing charges for forwarding data to the cloud server. The received data may include encrypted data, a destination identifier of the cloud server, and/or an identifier of the internet of things node. The forwarded data may include encrypted data, an identifier of the apparatus, an internet of things node identifier, an address in a database where payment to the apparatus can be made, and/or an address in a distributed database including blockchain where payment to the apparatus can be made. A reimbursement record and/or a credit record for the forwarded data may be received. The reimbursement record and/or a credit record may be received from a distributed database including blockchain and/or from the cloud server. Information indicative of a data forwarding transaction to the cloud server may be stored, in memory at the apparatus to enable processing of a charging record and/or a debit record, and the stored information may include an identity of the internet of things node and/or the identity of the cloud server.

In some example embodiments, there may be provided a method that includes detecting, by an internet of things node, a semi-open internet of things gateway configured to selectively forward, based on at a likelihood of reimbursement, data to a cloud server associated with the apparatus; sending, by the internet of things node, a request to access the semi-open internet of things gateway; and forwarding, by the internet of things node, data to the semi-open internet of things gateway for forwarding to the cloud server, when the semi-open internet of things gateway allows the requested access.

In some variations, one or more of the features disclosed herein including the following features can optionally be included in any feasible combination. The forwarded data may include encrypted data, a destination identifier of the cloud server, and/or an identifier of the apparatus The detection of the semi-open internet of things gateway may include a query to a server and/or a multicast link-local domain name server query.

In some example embodiments, there may be provided a method that includes receiving, from a semi-open internet of things gateway configured to selectively allow access based on at a likelihood of reimbursement, data including encrypted data, an identifier of the semi-open internet of things gateway, and an internet of things node identifier; receiving, by the internet of things server and from the semi-open internet of things gateway, a reimbursement request for a session associated with the received data; and sending by the internet of things server, an indication of reimbursement for the session.

In some variations, one or more of the features disclosed herein including the following features can optionally be included in any feasible combination. The indication may be sent to a distributed database including blockchain.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1A depicts an example of a system including IoT nodes, IoT gateways, and a corresponding IoT cloud server, in accordance with some example embodiments;

FIG. 1B depicts an example of a process for an IoT gateway to selectively forward IoT data, in accordance with some example embodiments;

FIG. 2 depicts another example of a process for an IoT gateway to selectively forward IoT data, in accordance with some example embodiments;

FIG. 3 depicts examples of processes for selectively forward IoT data, in accordance with some example embodiments; and

FIG. 4 depicts an example of an apparatus, in accordance with some example embodiments.

Like labels are used to refer to same or similar items in the drawings.

### DETAILED DESCRIPTION

IoT nodes may need to access an IoT gateway in order to access the Internet and a corresponding cloud server at which the IoT node's data can be processed further. The IoT node may include wireless transceiver circuitry to enable data transmission (and, this circuitry may be configured for reception as well) to other devices. For example, the wireless transceiver circuitry may be configured to provide cellular, IEEE 802.11 (WLAN), IEEE 802.11ah (e.g., low-power WLAN), Bluetooth, IEEE 802.15.4, Bluetooth Low-Energy, WirelessHART, and/or other radio access technologies. Regardless of the radio access technology, the IoT node may need to establish a connection to an IoT gateway providing connectivity to the Internet. The wireless connection(s) between the IoT node and this IoT gateway may require a subscription, key provisioning, or other kind of data provisioning to be in place for the IoT node and IoT gateway to allow the IoT node to find and accept the IoT gateway and to allow the IoT gateway to connect to the IoT node as well. If mobility is implemented, the complexity with respect to establishing the IoT-node-to-IoT-gateway connection may be made even more complex. Moreover, this complexity may be further exacerbated by mobility requirements as they grow from mobility within a building to a city, a country, and even among countries (which may include the IoT node and IoT gateway being configured with per-country subscriptions before use).

In some example embodiments, there is provided an IoT gateway that selectively serves IoT nodes by for example forwarding a given IoT node's data to a corresponding cloud server and subsequently seeking reimbursement for the data forwarding.

In some example embodiments, the IoT gateway may be considered “semi-open” as some IoT nodes may not be selected and thus not have their data forwarded to a corresponding cloud server. The semi-open IoT gateway may be configured to selectively forward data (which is received from an IoT node) to a cloud server. The IoT gateway may also obtain reimbursement for the forwarding of the IoT node's data. The reimbursement may be obtained from an entity associated with the cloud server (e.g., the cloud server’ owner) or other entity associated with the cloud server (including, for example, an entity associated with the IoT node itself, an owner of the IoT node, or other entity configured, or designated, to handle charging for the IoT node and/or IoT cloud server).

The IoT gateway may, in some example embodiments, choose to forward IoT data to a cloud server, when the IoT gateway determines that the cloud server and/or IoT node are likely to reimburse the IoT gateway for the data forwarding. When it is determined that reimbursement is likely for the forwarding service, the IoT gateway may select the IoT node for forwarding and then forward the IoT node's data to a corresponding IoT cloud server (also referred to herein as a cloud server). The IoT gateway may subsequently send a charge for reimbursement for the provided forwarding service. In some embodiments, the forwarding service to the cloud service may be provided with less delay (and/or with reduced power consumption as well), when compared to other approaches requiring payment before each forwarding transaction.

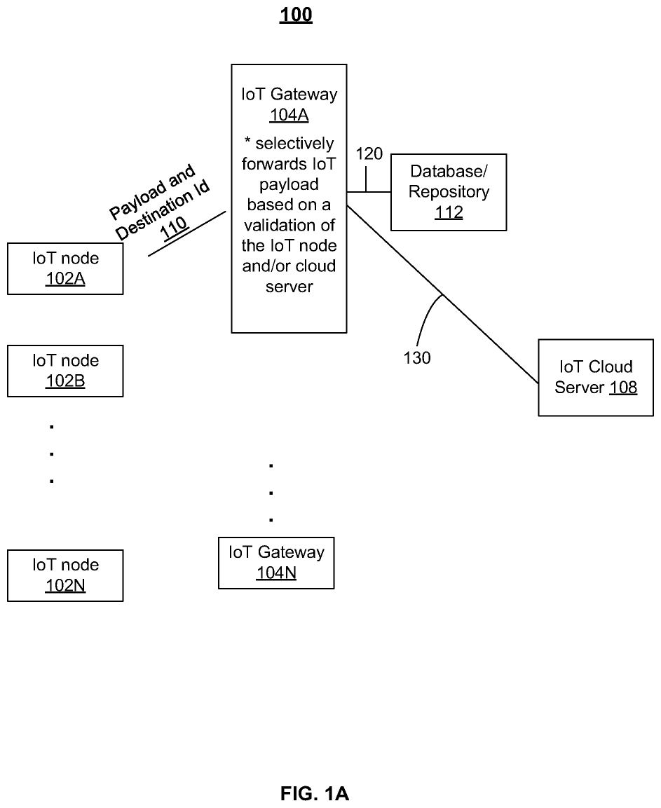

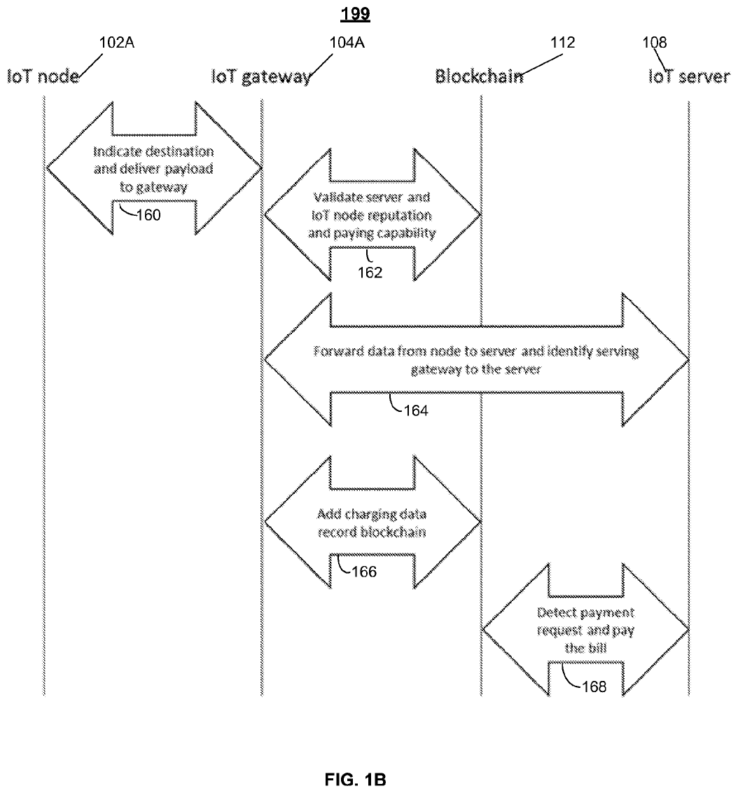

FIG. 1A depicts an example system 100 including an IoT gateway configured to selectively forward IoT data to a cloud server, in accordance with some example embodiments. The system 100 may include at least one IoT node 102A-N, at least one IoT gateway 104A-N, and at least one IoT cloud server 108. The system 100 may also include a repository or database 112, which in some example embodiments is implemented as a blockchain distributed database. Although some of the examples refer to blockchain, other types of databases and systems may be used as well.

In some example embodiments, an IoT node, such as IoT node 102A, may present a digital certificate (also referred to herein as a certificate) to an IoT gateway such as IoT gateway 104A, so that the IoT gateway can validate the received digital certificate against a certificate authority used for a reimbursement scheme (e.g., that reimburses for the IoT gateway's IoT data forwarding to the cloud server). The IoT gateway may establish a connection to the cloud server 108, and the IoT gateway may then validate the IoT cloud server's 108 certificate against the certificate authority used for the reimbursement scheme. If the certificates are valid (e.g., based on checks with a trusted certificate authority which may be associated with the reimbursement scheme), the IoT gateway may also check the reputation of the IoT node and/or cloud server with respect to payment for forwarding services. Although some of the examples refer to checking the certificate and the reputation, the IoT gateway may perform just a single check such as a check of the certificate of the IoT node and/or IoT gateway.

If a cloud server has a bad reputation (e.g., stops paying for the forwarding service provided by an IoT gateway), a certificate authority may publish the cloud server's certificate (or an identifier such as a serial number for the certificate) in a certificate revocation list (CRL), so that other gateways can recognize that the revoked cloud server is unlikely to reimburse for the data forwarding (so data forwarding to that cloud server may not be allowed). Although the previous example describes the CRL as including revoked certificates of IoT cloud servers, the CRL may also include the revoked certificates of IoT nodes that have a bad reputation for payment of forwarding services. In some example embodiments, the certificate may be in accordance with the X.509 standard, although other types of certificates may be used as well.

At 110A, the IoT gateway 104A may, in accordance with some example embodiments, receive from the IoT node 102A at least (1) data (e.g., data encrypted as an encrypted data blob or an encrypted data stream), (2) a destination identifier of, for example, the cloud server 108 (e.g., an identifier comprising the destination's uniform resource locator (URL), fully qualified domain name (FQDN), certificate, Internet Protocol (IP) address, and/or the like), and/or (3) an identifier of the IoT node (e.g., the IoT node's 102A certificate, IEEE identifier, IP or MAC address, and/or any other identifier or address), although other information may be received as well.

In some example embodiments, the IoT gateway 104A may receive (1)-(3) from the IoT node 102A to enable forwarding IoT data to the cloud server 108 indicated by the destination identifier. Moreover, the IoT gateway 104A may receive (1)-(3) over one or more wireless connections (although wired access may be used as well), without requiring radio access level authentication and/or provisioning by the IoT node 102A.

At 120, the IoT gateway 104A may, in accordance with some example embodiments, perform one or more checks on the IoT cloud server and/or IoT node to determine whether the data forwarding provided by the IoT gateway is likely to be reimbursed. To that end, the IoT gateway may check the certificate of the IoT cloud server and/or IoT node. Alternatively or additionally, the IoT gateway may check the reputation of the IoT cloud server and/or IoT node (e.g., whether the IoT node and/or cloud server have in the past reimbursed for IoT data forwarding, and may be checked via blockchain records or other sources). Alternatively or additionally, the IoT gateway may check a repository or database 112 (e.g., via a check of a blockchain or via a domain name server, DNS, check) to determine whether the IoT node 102A itself and the identified destination cloud server 108 are part of a reimbursement scheme that is likely to reimburse the IoT gateway for IoT data forwarding. Alternatively or additionally, the IoT gateway may check whether the IoT node 102A and/or cloud server 108 have a credit balance. In some example embodiments, the IoT gateway 104A may find the cloud server's 108 wallet address (e.g., via BitAlias which maps domain names to Bitcoin addresses and/or via some other database or service/resource). In some example embodiments, the IoT gateway 104A may check how much the cloud server 108 is willing to pay for IoT data forwarding (that payment information may be obtained from blockchain as well as other servers and/or databases, for example).

At 130, the IoT gateway 104A may forward (e.g., post, provide, send, and/or the like), the IoT data (which was received form the IoT node) to the cloud server 108, in accordance with some example embodiments. The IoT gateway 104A may record this transaction into memory to enable validation of processing charges from the IoT gateway, in accordance with some example embodiments.

In some example embodiments, the IoT gateway 104A may seek reimbursement for forwarding the IoT node's 102A data to the cloud server 108. To seek reimbursement, the IoT gateway may send a charging data record, CDR, or bill, directly to the cloud server that received the forwarded IoT data, in accordance with some example embodiments. The IoT gateway may seek reimbursement from the IoT cloud server at any time, but in some example embodiments, the IoT gateway reimbursement request may be triggered when a predefined transaction volume threshold is reached (e.g., after a given quantity of data is forwarded to the cloud server). Alternatively or additionally, the reimbursement request may be triggered by a predefined time, such as the expiry of a timer or other event.

To seek reimbursement, the IoT gateway may post a “debt” transaction into the blockchain, in accordance with some example embodiments. In the case of blockchain, the payer is the cloud server 108 and the payee/receiver is the IoT gateway 104 (e.g., gateway's wallet). Moreover, the transaction may need to be digitally signed using for example the cloud server's certificate, key, and/or the like before the reimbursement transaction is fully valid and credits move to the IoT gateway's wallet.

In the case of blockchain, the cloud server 108 may detect it needs to pay one or more IoT gateway(s) that have forwarded data to the cloud server 108. If the blockchain contains a certain amount of unfulfilled transactions (which are not deemed illegitimate by an escrow service, for example), the cloud server's (or cloud server's wallet) reputation can decrease. However, when a payment is made for the forwarded IoT data, the reputation of the IoT sensor and the cloud server may each increase (although the cloud server's reputational increase may not be as substantial as the IoT sensor's increase). On the other hand, non-payment may decrease the reputation of the IoT sensor substantially, while the reputation of the cloud server may decrease as well (although the cloud server's decrease may not be as substantial as the IoT sensor's decrease).

In some example embodiments, an IoT gateway may need to identify itself to a cloud server, so that the cloud server can properly reimburse fees to the IoT gateway (or, for example, other entity associated with the gateway, the gateway's owner, and/or the like). When an application proxy is used (e.g., HTTP proxy, CoAP proxy, SOCKS proxy, MQTT proxy and/or any other type of application proxy), the IoT gateway 102A may identify itself to the cloud server 108 with a certificate, such as a TLS client certificate, although the IoT gateway may be identified in other ways as well (e.g., using packet header information as well as other protocols). When the IoT gateway seeks reimbursement and invoices the cloud server (e.g., by sending a charging record), the IoT gateway may sign for example an invoice (or charging record) with the IoT gateway's key, such as gateway's private wallet key. In this way, the cloud server can later determine that the invoice is from the same IoT gateway that forwarded the data. In some embodiments, the charging record is a blockchain transaction that transfers payment from the cloud server's wallet to IoT gateway's wallet. When this is the case, the cloud server may then need to sign the transaction and post it to the blockchain.

In some example embodiments, the IoT node may request the IoT gateway to open a pinhole for communications via a Port Control Protocol (PCP) extended so the IoT node can ask for a path to be opened to a given destination IP. The IoT gateway may then open a pinhole only when the data appears to be reimbursable as disclosed herein. The IoT gateway may then monitor and meter traffic volumes being forwarded to the specified IP, and may then create a charging record to enable reimbursement for the forwarded data. When PCP is used to open a pinhole, the actual traffic between IoT node and IoT server may be sent end-to-end, TLS secured. In the case of PCP, the IoT gateway may only be able to monitor data volumes of that connection, and seek reimbursement/charge accordingly.

When the IoT gateway 104A obtains, from an IoT node 102A, the destination identifier of the cloud server, the IoT gateway 104A may, in some example embodiments, directly forward the data to the cloud server 108. For example, when the IoT gateway receives the IoT data and cloud server destination ID at 110, the IoT gateway may directly send, at 130, the encrypted IoT data to the cloud server's ID, without meaningful checks on the IoT node or cloud server likelihood of reimbursing the IoT gateway. Moreover, the IoT gateway may also provide the IoT gateway's identity as well, so that cloud server 108 can provide reimbursement to the IoT gateway. Moreover, the IoT gateway may generate corresponding charging records for the data forwarding. This approach may result in a low rate of reimbursement, when compared to some of the approaches noted below. As such, this forward without verifying approach may be better suited in a closed and trusted system framework.

Alternatively or additionally, the IoT gateway, may, in some example embodiments, verify based on one or more checks as noted herein whether the cloud server is supported and/or reputable with respect to reimbursement before allowing the IoT gateway to forward data to the cloud server. Based on the verification, the IoT gateway may then forward the IoT data along with an IoT gateway identifier to allow the cloud server to later reimburse the IoT gateway. Alternatively or additionally, the IoT gateway, may, in some example embodiments, verify the IoT node is valid (e.g., check whether the IoT node's certificate is valid and/or a check of the IoT node's reputation regarding reimbursement of IoT data forwarding charges). Based on this check (and/or other checks) of the IoT node, the IoT gateway may then forward the data to the IoT cloud server. Alternatively or additionally, the IoT gateway, may, in some example embodiments, verify both IoT node's and destination server's reputation and certificate validity, before forwarding data to the cloud server. Here, the IoT gateway may check the IoT node's certificate and reputation and may check the cloud server's certificate and reputation. Based on these checks of the IoT node and/or IoT cloud server, the IoT gateway may then forward the data to the IoT cloud server.

In some example embodiments, an IoT gateway may blacklist a cloud server that refuses to reimburse an IoT data transmission fee. When this is the case, the particular IoT gateway may choose to not forward data to that cloud server. Moreover, the IoT gateway may share the blacklist decision with other devices including other IoT gateways, databases, repositories, and/or the like (e.g. using blockchain) in order to decrease the cloud server's reputation.

An IoT node may detect the presence of these semi-open gateways in a variety of ways. For example, the IoT node may detect the presence of a semi-open gateway by receiving a WLAN beacon message advertising the presence of a certain WLAN Service Set Identifier (SSID), receiving a Bluetooth/Bluetooth Low Energy advertisement message advertising IoT gateway service, sending a multicast message to a certain multicast IP/IPv6 address, performing a local-scope domain name query with multicast DNS (e.g. reimbursementproxy.local), or activating a cellular connection with a certain 3GPP IoT access point name (APN). In the case of a cellular IoT APN, the cellular IoT APN may not directly charge the IoT node's cellular subscription, but may instead reimburse the cloud server as described herein.

In some example embodiments, the cloud server 108 may indicate in blockchain 112 (or at another database/repository) how much the cloud server is willing to pay for IoT forwarded data. For example, the cloud server 108 may indicate that it is willing to pay 0.01€ for each kilobyte of acceptable payload data forwarded to the cloud server by an IoT gateway 104A. When this is the case, the IoT gateway 104A may check the indicated amount when deciding whether to select the IoT node 102A for forwarding to the cloud server 108.

When the IoT node 102A sends at 110 data to an IoT gateway 104A for forwarding to cloud server 108, the cloud server's destination identifier may take a variety of forms. For example, the destination identifier may include an URL describing where the cloud server is located. An example of this URL is as follows: https://iot.nokia.com/iotpay?ici=12345. In this HTTP example, a request for HTTP proxy to perform a POST operation may be used with a message header: POST https://iot.nokia.com/iotpay?id=12345 HTTP/1.1, for example. Moreover, the data payload may be encrypted as well with a suitable encryption technology. To illustrate, when RSA encryption is being used, a data payload (which may be smaller than the encryption key) can be encrypted with cloud server's public key. The encrypted data may then be sent to the cloud server, where the data is decrypted with cloud server's private key. Although the previous example refers to RSA encryption, other encryption technologies may be used as well including AES, DES, Triple-DES, and/or the like.

With an URL's fully qualified domain name (FQDN) such as “iot.nokia.com” for example, the IoT gateway 104A may, as noted, check a repository/server 112 (e.g., a DNS and/or a blockchain) with the FQDN of the cloud server to determine whether the cloud server is likely to reimburse the IoT gateway (e.g., has a history or reputation of paying IoT data forwarding fees). Alternatively or additionally, the IoT gateway 104A may send a direct query to the cloud server's identifier (or query another resource) to determine whether the cloud server is likely to reimburse the IoT gateway.

The IoT node may communicate with the IoT gateway in a variety of ways. For example, an HTTP reimbursement proxy (such as a restful reimbursement proxy) may be used. To illustrate further, the IoT node may perform a multicast link-local DNS query via an attached link for “reimbursementgateway.local” name. And, if that query resolves to an IP address, the IoT node may establish a connection to the IoT gateway (e.g., via a TLS connection to the resolved IoT gateway's IP address). This connection may also provide the IoT node's client certificate to the IoT gateway. At this point, the IoT node can also verify the IoT gateway's server certificate (received as part of a TLS handshake) is signed by a trusted authority and is valid. The IoT node may post the destination server URL and encrypted data payload to the IoT gateway via HTTPS, for example. The IoT gateway may then establish a TLS connection to the destination URL of the cloud server, verify the cloud server's server certificate (received as part of a TLS handshake) is signed by a trusted authority and is valid. The IoT gateway may then forward to the cloud server via the connection the IoT data and IoT node identity, such as IoT node's client certificate. Moreover, the IoT gateway may identify itself to the cloud server using the IoT gateway's client certificate. Thus for a given IoT data forwarding transaction/session, the cloud server may have knowledge of the IoT gateway's identity and the IoT node that was the source of the forwarded IoT data.

Although the previous example refers to HTTPS based forwarding, the forwarding may be performed with other protocols including SOCKS-proxy, CoAP-proxy, MQTT-proxy, and/or the like.

Alternatively or additionally, the IoT node may communicate with the IoT gateway via PCP as noted above. For example, the IoT node may query the IoT gateway to open a pinhole to the given destination IP and port for the cloud server. However, before granting that port and forwarding the data between IoT node and IoT gateway, the IoT gateway may check whether the indicated destination cloud server is likely to reimburse the IoT gateway for IoT data forwarding (e.g., based on validity and/or reputational checks of the IoT node and/or cloud server).

FIG. 1B depicts an example of a signaling diagram 199, in accordance with some example embodiments. The signaling diagram depicts an IoT node 102A, an IoT gateway 104A, a repository or distributed database 112 (labeled blockchain), and a cloud server 108.

At 160, the IoT node 102A may send to the IoT gateway 104A a data payload and an identifier of a destination for the payload, in accordance with some example embodiments. For example, IoT node 102A may need to send payload data, such as IoT data, to the cloud server 108 to allow further processing. However, the IoT node 102A may need the IoT gateway to provide access to the Internet, which interfaces the cloud server 108. When this is the case, the IoT node 102A may send to the IoT gateway 104A IoT data and a destination identifier for that data such as the destination cloud server 108.

At 162, the IoT gateway 104A may perform one or more checks on the cloud server and/or the IoT node, in accordance with some example embodiments. As noted above, the IoT gateway may check the validity of the certificates of the cloud server and/or the IoT node, check the reputation regarding the cloud server's (or IoT node's) past payment history for IoT data forwarding, and/or perform other checks to assess the likelihood the IoT cloud server 108 and/or IoT node 102A may pay the IoT gateway (or other associated entity) for the IoT data forwarding.

At 164, the IoT gateway 104A may forward, based on the checks, to the IoT cloud server 108 IoT data and/or the IoT gateway's identity. For example, if the checks of the cloud server indicate that the cloud server is likely to pay (or is capable of paying), the IoT gateway 104A may forward to the IoT cloud server 108 the IoT data (which was received form the IoT sensor). Moreover, the IoT gateway 104A may forward to the IoT cloud server 108 the IoT gateway's identity, such as an IP address, certificate, FQDN, and/or the like of the IoT gateway 104A. In this way, the cloud server 108 can determine the identity of the forwarding gateway for a given IoT data forwarding transaction.

At 166, the IoT gateway 104A may generate charging records for the data forwarding to the cloud server 108, in accordance with some example embodiments. The charging record may be sent to the cloud server 108 directly and/or to another entity, such as a database or repository 112. In the example of FIG. 1B, the charging record is sent to a distributed database such as blockchain to enable recording the charge to the cloud server 108.

At 168, the cloud server 108 may detect that payment is due and pay the charge for the IoT data forwarding service provided by the IoT gateway 104A, in accordance with some example embodiments. In the example of FIG. 1B, payment for the charge is sent to a distributed database such as blockchain, although the payment can be made in other ways as well.

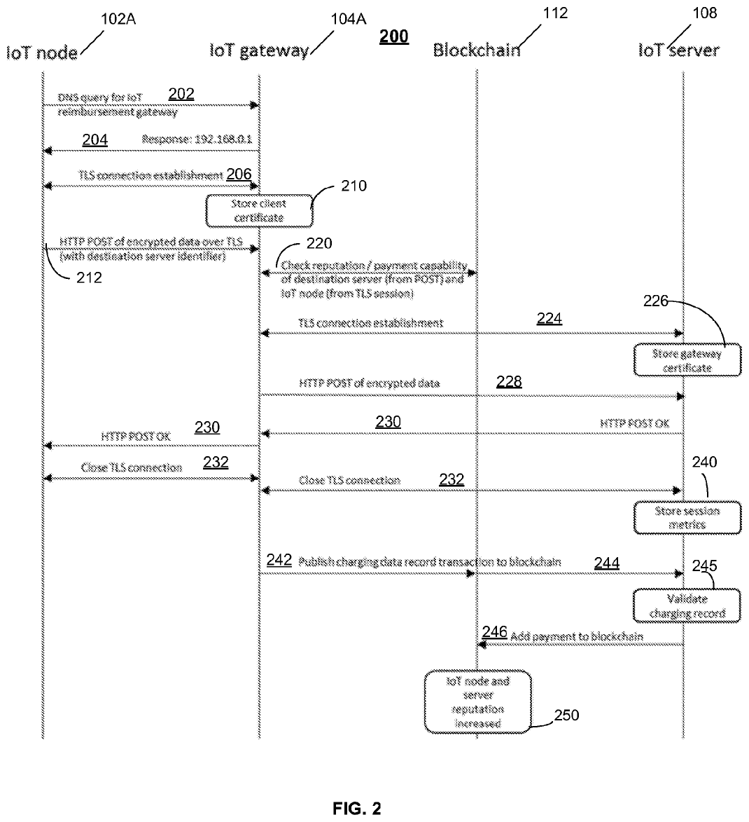

FIG. 2 depicts another example of a signaling diagram 200, in accordance with some example embodiments.

At 202, the IoT node 102A may perform a query to identify an IoT gateway, in accordance with some example embodiments. To discover the IoT gateway, the IoT node may perform a multicast link-local DNS query on an attached link for a local gateway that supports the reimbursement disclosed herein (e.g., query for “reimbursementgateway.local” name). If that query resolves at 204 to an IP address, the IoT node may establish a connection 206 to the resolved address which will be an IoT gateway configured to provide IoT data forwarding in accordance with some example embodiments. Although the IoT gateway can be discovered using multicast link-local DNS query, other discovery techniques may be used as well.

At 210, the IoT gateway 104A may store a certificate associated with the IoT node 102A to the IoT gateway 104A, in accordance with some example embodiments. At 212, the IoT node 102A may forward the IoT data, in accordance with some example embodiments. In the example of FIG. 2, the forwarding takes place via a HTTP post of the encrypted data over the connection established at 206. The HTTP post may also include the cloud server 108 destination identity.

At 220, the IoT gateway 104A may perform one or more checks on the IoT node 102A and/or the cloud server 108, in accordance with some example embodiments. In the example of FIG. 2, the IoT gateway may check the reputation of the IoT node 102A and/or cloud server 104A via a database such as blockchain 112. The check may also include the validation of the certificates for the IoT node and/or IoT gateway, and/or other checks that may indicate whether the IoT server and/or IoT node are likely to reimburse the IoT gateway for the data forwarding.

At 224, the IoT gateway 104A may establish a connection to the cloud server 108, in accordance with some example embodiments. For example, the connection may be established as a TLS connection, although other types of connections may be established as well. At 226, the cloud server 108 may store the IoT gateway's certificate, in accordance with some example embodiments. At 228, the IoT gateway 104A may forward the IoT node's identity and IoT data, in accordance with some example embodiments. For example, the IoT gateway may forward the IoT data using an HTTP post of the encrypted IoT data. At 230, the cloud server 108 may acknowledge receipt, in accordance with some example embodiments. And, in response to the acknowledgement, the IoT node may initiate closing, at 232, of the connection, in accordance with some example embodiments. At 240, the cloud server 108 may store metrics for the session, such as the volume of data received, number of performed events, time of day, identity of the IoT gateway, and/or identity of IoT node, in accordance with some example embodiments. At 242, the IoT gateway may publish a charging record for the IoT data forwarding transaction or session, in accordance with some example embodiments. For example, the IoT gateway may forward the charging record to a database 112, although the charging record can be sent directly to the cloud server 108 as well.

At 246, the cloud server may detect that payment is due and pay the charge for the IoT data forwarding service provided by the IoT gateway 104A, in accordance with some example embodiments. In the example of FIG. 2, when the charging record is provided to repository or database 112, the cloud server 108 can detect at 244 that event, which prompts the cloud server to validate at 245 the charging record (e.g., validate the charge based on the stored session metrics at 240) prior to paying the charge at 246. At 250, the repository or database 112 may increase the reputation of the cloud server and/or IoT node with respect to their likelihood to pay IoT data forwarding charges, in accordance with some example embodiments.

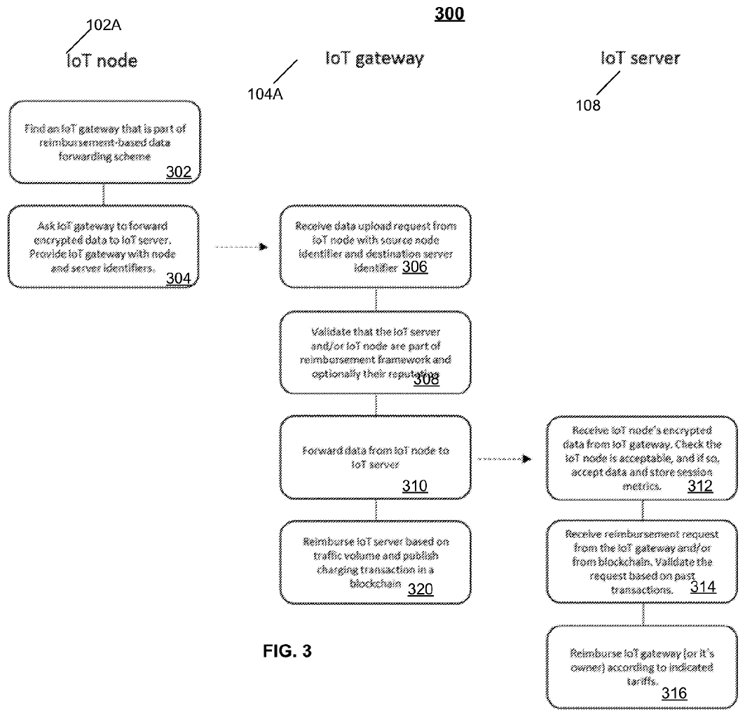

FIG. 3 depicts a process flow 300 for the IoT node 102A, IoT gateway 104A, and IoT server, in accordance with some example embodiments.

At 302, the IoT node 102A may discover an IoT gateway that is configured to selectively forward IoT data, in accordance with some example embodiments. At 304, the IoT node 102A may request the discovered IoT gateway 104A to forward encrypted data to a cloud server, in accordance with some example embodiments. To that end, the IoT node 102A may provide the IoT node's identity and/or the cloud server's identity. At 306, the IoT gateway may receive the encrypted data from the IoT node as well as the identifiers for the cloud server (and/or IoT node), in accordance with some example embodiments. At 308, the IoT gateway may perform checks, in accordance with some example embodiments. For example, the IoT gateway may check whether the IoT node and/or IoT cloud server are likely to reimburse the IoT gateway. The check may include checking the reputation of the IoT node and/or IoT cloud server. Alternatively or additionally, the check may assess whether the IoT node and/or cloud server are part of a IoT data forwarding reimbursement framework. Alternatively or additionally, the check may assess the certificates of the IoT node and/or cloud server. At 310, the IoT gateway may forward to the cloud server the IoT data based on the results of the checks at 308, in accordance with some example embodiments.

At 312, the cloud server may receive the IoT node's data, which may be encrypted, in accordance with some example embodiments. The cloud server may check whether the IoT node is a node for which it processes data, and the cloud server may store session metrics as noted above at 240.

At 320, the IoT gateway may seek reimbursement for the IoT data forwarding by publishing charge record(s) to a database or other repository, such as blockchain, in accordance with some example embodiments. At 314, the cloud server may receive or detect the reimbursement request published at 320, and after validating the request for reimbursement pay the reimbursement at 316.

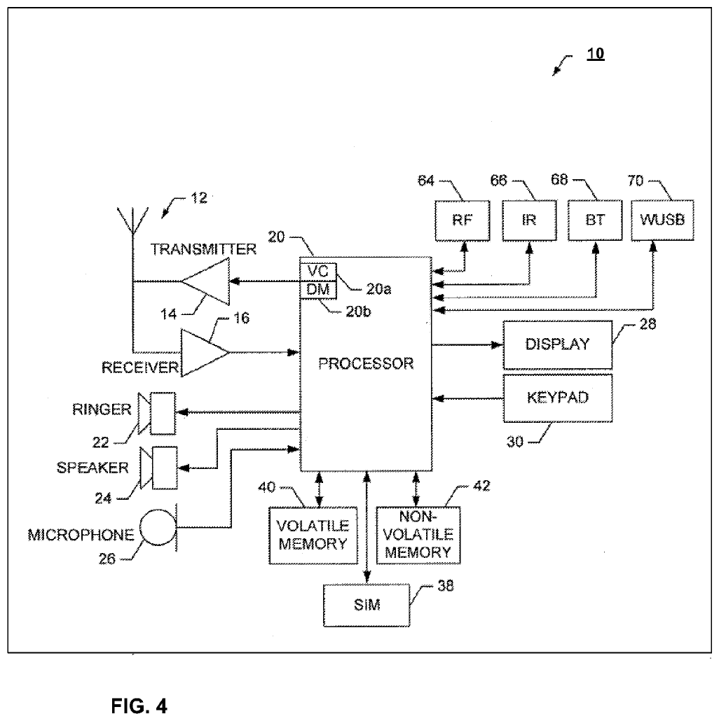

FIG. 4 illustrates a block diagram of an apparatus 10, in accordance with some example embodiments. The apparatus 10 (or portions thereof) may be configured to provide an IoT device and/or an IoT gateway.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 4 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 4, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein. The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to control and/or provide one or more aspects disclosed herein (see, for example, processes 199, 200, and/or 300).

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 4, computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein is enabling IoT gateways to more likely provide data forwarding for IoT nodes, reduce delays associated with data forwarding, and/or reduce power consumption.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1-50. (canceled)

51. An apparatus comprising:
at least one processor; and
at least one memory comprising program code which when executed configures the apparatus to at least:
receive, from an internet of things node, data to be forwarded to a cloud server and an identity of the cloud server;
perform at least one check of the internet of things node and/or the cloud server, to assess whether the apparatus is likely to be reimbursed for a charge for forwarding the data to the cloud server; and
forward, based on the at least one check, the data to the cloud server.

52. The apparatus of claim 51, wherein the apparatus is further configured to at least send a charging record and/or debit record for the forwarded data, when the forwarded data is sent to the cloud server.

53. The apparatus of claim 52 wherein the charging record and/or debit record is sent to a distribute database comprising blockchain and/or sent to the cloud server.

54. The apparatus of claim 51, wherein the at least one check to assess whether the apparatus is likely to be reimbursed comprises a check of a first certificate for the internet of things node and/or a second certificate for the cloud server.

55. The apparatus of claim 51, wherein the at least one check to assess whether the apparatus is likely to be reimbursed comprises a check of a reputation of the internet of things node and/or the cloud server for reimbursement for forwarding data to the cloud server.

56. The apparatus of claim 51, wherein the at least one check to assess whether the apparatus is likely to be reimbursed comprises a verification of whether the internet of things node and/or the cloud server comprise credit for reimbursing charges for forwarding data to the cloud server.

57. The apparatus of claim 51, wherein the received data comprises encrypted data, a destination identifier of the cloud server, and/or an identifier of the internet of things node.

58. The apparatus of claim 51, wherein the forwarded data comprises encrypted data, an identifier of the apparatus, an internet of things node identifier, an address in a database where payment to the apparatus can be made, and/or an address in a distributed database comprising blockchain where payment to the apparatus can be made.

59. The apparatus of claim 51, wherein the apparatus is further configured to at least receive a reimbursement record and/or a credit record for the forwarded data.

60. The apparatus of claim 59, wherein the reimbursement record and/or a credit record is received from a distributed database comprising blockchain and/or from the cloud server.

61. The apparatus of claim 51, wherein the apparatus is further configured to at least store, in memory at the apparatus, information indicative of a data forwarding transaction to the cloud server to enable processing of a charging record and/or a debit record, the stored information comprising an identity of the internet of things node and/or the identity of the cloud server.

62. A method comprising:
receiving, from an internet of things node, data to be forwarded to a cloud server and an identity of the cloud server;
performing at least one check of the internet of things node and/or the cloud server, to assess whether the apparatus is likely to be reimbursed for a charge for forwarding the data to the cloud server; and
forwarding, based on the at least one check, the data to the cloud server.

63. The method of claim 62, further comprising:
sending a charging record and/or debit record for the forwarded data, when the forwarded data is sent to the cloud server.

64. The method of claim 63 wherein the charging record and/or debit record is sent to a distribute database comprising blockchain and/or sent to the cloud server.

65. The method of claim 62, wherein the at least one check to assess whether the apparatus is likely to be reimbursed comprises a check of a reputation of the internet of things node and/or the cloud server for reimbursement for forwarding data to the cloud server.

66. The method of claim 65, wherein the check of the reputation comprises verifying the reputation at a database comprising historical data regarding past reimbursements for forwarding data to the cloud server.

67. The method of claim 65, wherein the check of the reputation comprises verifying the reputation at a distributed database comprising blockchain.

68. The method of claim 62, wherein the at least one check to assess whether the apparatus is likely to be reimbursed comprises a verification of whether the internet of things node and/or the cloud server comprise credit for reimbursing charges for forwarding data to the cloud server.

69. The method of claim 62, wherein the forwarded data comprises encrypted data, an identifier of the apparatus, an internet of things node identifier, an address in a database where payment to the apparatus can be made, and/or an address in a distributed database comprising blockchain where payment to the apparatus can be made.

70. A non-transitory computer-readable storage medium comprising program code which when executed causes operations comprising:
receiving, from an internet of things node, data to be forwarded to a cloud server and an identity of the cloud server;
performing at least one check of the internet of things node and/or the cloud server, to assess whether the apparatus is likely to be reimbursed for a charge for forwarding the data to the cloud server; and
forwarding, based on the at least one check, the data to the cloud server.
